(19) United States
(12) Patent Application Publication
(10) Pub. No.: US 2023/0383770 A1
(43) Pub. Date: Nov. 30, 2023

(54) SAFETY VALVE ARRANGEMENT AND ACTUATOR SYSTEM

(71) Applicant: Festo SE & Co. KG, Esslingen (DE)

(72) Inventors: Bernd BELLINGRODT, Rechberghausen (DE); Christian BÄURLE, Bissingen (DE); Thomas BEYERLEIN, Stuttgart (DE)

(21) Appl. No.: 18/323,841

(22) Filed: May 25, 2023

(30) Foreign Application Priority Data
May 27, 2022 (DE) 10 2022 113 470.9

(51) Int. Cl. F15B 13/042; F15B 13/04; F16K 31/122; F16K 31/126

(52) U.S. Cl. CPC F15B 13/0426; F15B 13/0401; F16K 31/122; F16K 31/126

(57) ABSTRACT

A safety valve arrangement includes a fluid distributor to which a first supply valve, a first pilot valve and a first safety valve are assigned. The first supply valve selectively releases or blocks a first supply channel extending in the fluid distributor between a first supply port and a first working port. The first pilot valve selectively releases or blocks a first pilot channel extending in the fluid distributor between a first pilot air inlet and a first pilot air outlet, and the first safety valve selectively releases or blocks a first safety channel which extends between the first working port and a first safety outlet. A first separation channel, which is permanently open to the environment, is located between the first supply channel and the first pilot channel to ensure a fluid separation between the first supply channel and the first pilot channel.

This application claims priority to German application 10 2022 113 470.9, filed May 27, 2022, which is incorporated by reference.

The invention relates to a safety valve arrangement for a protected pneumatic supply to an actuator.

### SUMMARY OF THE INVENTION

The task of the invention is to provide a safety valve arrangement with a compact design.

This task is solved for a safety valve arrangement in that the safety valve arrangement has a fluid distributor to which a first supply valve, a first pilot valve and a first safety valve are assigned, the first supply valve selectively releases or blocks a first supply channel which is formed in the fluid distributor and which extends between a first supply port and a first working port, wherein the first pilot valve selectively releases or blocks a first pilot channel formed in the fluid distributor and extending between a first pilot air inlet and a first pilot air outlet, and wherein the first safety valve selectively releases or blocks a first safety channel extending between the first working port and a first safety outlet in dependence on pressurization of the first pilot air outlet, wherein between the first supply channel and the first pilot channel a first separation channel is extended which is permanently open to the environment and which is designed for a safety oriented fluid separation between the first supply channel and the first pilot channel.

In principle, it is possible to fluidically interconnect the components of the safety valve assembly by discrete fluid hoses in the required manner, but this does not allow a particularly compact spatial design for the safety valve assembly due to the space required for the fluid hoses and the respective fluid hose couplings required. In addition, the large number of fluid hose couplings also poses a certain functional risk for the safety valve assembly.

According to the invention, it is therefore intended to use a compact fluid distributor for the safety valve arrangement, in which several fluid channels are formed to fluidically connect the valves of the safety valve arrangement. It is also provided that the valves of the safety valve arrangement are assigned to the fluid distributor, in particular are attached or mounted to the fluid distributor or are optionally accommodated at least partially in corresponding recesses in the fluid distributor. If valves are accommodated in the fluid distributor, these valves can either be functionally decoupled from the fluid distributor, so that the respective recess in the fluid distributor merely represents a mounting shaft in which the valve, which can also function without the fluid distributor, can be accommodated. Alternatively, at least a section of an inner wall of the recess in the fluid distributor can be designed as a housing component of the valve to be accommodated thereon. For example, it can be provided that the inner wall of the recess bounds a working space in which a valve member is movably, in particular linearly movably, accommodated, wherein the valve member can be used, depending on a position along a rectilinear or curved movement path, for a release or a blocking of a fluidically communicating connection between fluid channels which are formed in the fluid distributor and open into the recess.

At least a first supply valve, a first pilot valve and a first safety valve are associated with the fluid distributor. The first supply valve has the task of selectively blocking or releasing a fluidically communicating connection between a working fluid source, in particular a compressed air source, which can be connected to a first supply port, and a first working port to which an actuator, for example a pneumatic cylinder or a pneumatic swivel drive, can be connected.

For this purpose, a first supply channel is provided in the fluid distributor, which comprises a first supply channel section extending from the first supply port to a first orifice at an interface for the first supply valve. Furthermore, the first supply channel comprises a second supply channel section extending from a second orifice associated with the interface for the first supply valve to the first working port. Accordingly, the supply valve can be fluidically coupled into the supply channel between the first orifice and the second orifice and, with its valve member and an associated valve seat as well as an actuator associated with the valve member, in particular a solenoid actuator or a piezo actuator, effect the desired selective release or blocking of the supply channel. In this case, the first supply valve is preferably designed as a 2/2-way valve, preferably as a switching valve or, in particular, as a proportional valve.

Depending on the design of the actuator which is to be connected to the safety valve arrangement, it can also be provided that, starting from a third orifice which is assigned to the interface for the first supply valve, a third supply channel section is extended up to an outlet connection to which a working fluid sink, preferably a compressed air sink, in particular a compressed air outlet, can be connected or formed, so that the first supply valve can also effect a compressed air discharge from the actuator. In this case, the first supply valve can be designed, for example, as a 3/3-way valve.

Furthermore, a first pilot channel is formed in the fluid distributor, which extends between a first pilot air inlet and a first pilot air outlet, wherein the first pilot channel has a first pilot channel section which extends from the first pilot air inlet to a first orifice at an interface for attachment of the first pilot valve. Further, the first pilot channel has a second pilot channel section extending from a second orifice at the interface for attachment of the first pilot valve to the first pilot air outlet. Accordingly, the first pilot valve is fluidically arranged between the first pilot channel section and the second pilot channel section and enables selective release or blocking of the first pilot channel via a valve seat and a valve member movably associated with the valve seat. Preferably, the first pilot valve is a 2/2-way valve, for example a solenoid valve or a piezo valve.

The first safety valve is designed as a fluidically pilot-controlled valve and is switched between a first functional position and a second functional position by pressurizing the first pilot air outlet with a pressurized working fluid, in particular compressed air. Preferably, the first safety valve is designed in such a way that, in the absence of pressurization of the first pilot air outlet, it assumes a release position, also referred to as the first functional position, in which there is a fluidically communicating connection between the first working port and a first safety outlet. When the first pilot air outlet is pressurized, the first safety valve assumes a blocking position, also referred to as the second functional position, in which the fluidically communicating connection between the first working port and the first safety outlet is interrupted. Preferably, the first safety valve is designed as a 2/2-way valve.

In order to ensure reliable operation of the first safety valve, the fluid distributor is provided with a first separation channel, which is formed between the first supply channel and the first pilot channel in the fluid distributor and which has the task of separating the first pilot channel from the first supply channel, to divert any pressurized working fluid escaping from the first supply channel before this working fluid could possibly enter the first pilot channel and thereby cause undesired actuation of the fluidically pilot-controlled first safety valve. Preferably, the first separation channel has several venting openings through which a discharge of pressurized working fluid into the environment can be ensured. Particularly preferably, a cross-section of the separation channel as well as cross-sections of the vent openings are selected in such a way that even in the event of a transfer of pressurized working fluid from the first supply channel into the first separation channel, no pressure increase can take place in the first separation channel, which could cause an undesired actuation of the fluidically pilot-controlled first safety valve, if there were additionally a fluidically communicating connection between the first separation channel and the first pilot air outlet.

Advantageous further developments of the invention are the subject of the sub-claims.

It is expedient if the fluid distributor has a first channel plate and a second channel plate, wherein the first supply channel and the first pilot channel and the first safety channel and the first separation channel are formed as a groove in a first inner surface of the first channel plate and/or in a second inner surface of the second channel plate and wherein the first inner surface and the second inner surface are connected to one another in a sealing manner, in particular by a material bond. Such a division into two parts makes it possible to manufacture the fluid distributor in a cost-effective plastic injection molding process, whereby a sealing connection between the first channel plate and the second channel plate must be created following the manufacture of the first channel plate and the second channel plate, which can preferably be ensured by a material-locking connection, in particular by bonding or ultrasonic welding. In this case, the first supply channel and/or the first safety channel and/or the first separation channel are designed as a groove-shaped recess in the form of a channel on a first inner surface of the first channel plate and/or on a second inner surface of the second channel plate. Alternatively, the fluid distributor can be manufactured in one piece in a generative manufacturing process, in particular a plastic laser sintering process or a metal laser sintering process, whereby the separation channel also provides additional safety in such a manufacturing method.

In particular, in a two-part or multi-part design of the fluid distributor, the task of the separation channel is to prevent fluid flows between the first supply channel and the first pilot channel, as could occur, for example, in the event of inadequate bonding or welding of the two cold plates or in the event of a possibly defective generative manufacturing process.

It is advantageous if the first inner surface and the second inner surface are geometrically corresponding to each other, in particular are both of flat shape. This provides the sealing surfaces necessary for fluidic separation of the individual channels on the two channel plates. It is advantageous if the first inner surface and the second inner surface are flat with respect to the channels introduced therein.

In a further development of the invention, it is provided that a first supply valve interface for attaching the first supply valve and a first pilot valve interface for attaching the first pilot valve are formed on a first outer surface of the first channel plate, which first outer surface is facing away from the first inner surface, wherein the first supply channel has a first supply channel section extending between the first supply port and a first interface port and a second supply channel section extending between a second interface port and the first working port, and wherein the first pilot channel has a first pilot channel section extending between the first pilot air input and a first interface port and a second pilot channel section extending between a second interface port and the first pilot air output. Such a configuration of the first channel plate allows the use of discretely constructed valves for use as a first supply valve or first pilot valve. These discretely constructed valves are fully functional independently and can thus be tested separately and also easily replaced in the event of damage. Preferably, the first supply valve and/or the first pilot valve are designed as solenoid valves or piezo valves, in particular as piezo bending valves.

In a further embodiment of the invention, a first valve recess is formed in the fluid distributor for the first safety valve, and the first pilot air outlet opens into a first working space bounded by the first valve recess and a first safety valve member movably received in the first valve recess, wherein the first safety valve member is biased in the first valve recess into a first functional position, in which the first safety channel is unblocked, and wherein the first safety valve member assumes a second functional position, in which the first safety channel is blocked, when the first working chamber is pressurized with a control pressure.

It is preferably provided that a second supply valve, a second safety valve and a second pilot valve are arranged on the fluid distributor, the second supply valve being designed for selective release or blocking of a second supply channel formed in the fluid distributor and extending between a second supply port and a second working port, wherein the second pilot valve is configured for selectively releasing or blocking a second pilot channel formed in the fluid distributor and extending between a second pilot air inlet and a second pilot air outlet, and wherein the second safety valve is configured for selectively releasing or blocking a second safety channel extending between the first working port and the second working port, the separation channel being disposed between the second supply channel and the second pilot channel.

With the second supply valve, an additional supply of pressurized fluid for pressurizing the actuator and, if necessary, venting of the actuator can be carried out independently of the first supply valve. Such an independent control of the actuator is of particular interest if the actuator has two working chambers, each of which can be supplied with pressurized fluid, as is the case, for example, with a double-acting pneumatic cylinder or a double-acting pneumatic rotary actuator. The second safety valve can preferably be arranged in a fluidic parallel circuit to the first safety valve, so that a simple redundancy is created for the function of the first safety valve by the second safety valve.

In this configuration of the fluid distributor, the first supply channel and the second supply channel are arranged on one side of the separation channel, while the first pilot channel and the second pilot channel are arranged on another side of the separation channel and are thus fluidically isolated from the first and second supply channels.

In a further embodiment of the invention, it is provided that the first safety outlet is connected to the second working port and/or that a second valve recess is formed in the fluid distributor for the second safety valve and that the second pilot air outlet opens into a second working space bounded by the second valve recess and a second safety valve member movably received in the second valve recess, wherein the second safety valve member is biased in the second valve recess into a first functional position in which the second safety channel is unblocked, and wherein the second safety valve member assumes a second functional position in which the safety channel is unblocked when the second working chamber is pressurized with a control pressure.

Preferably, the first safety valve and the second safety valve are fluidically connected to the first working port and the second working port in such a way that each of the two safety valves forms a fluidically communicating connection between the first working port and the second working port in the release position. In this way, in the event that a safety function is triggered for the actuator fluidically controlled by the safety valve arrangement, for example by actuation of an emergency stop switch by an operator, rapid pressure equalization can be effected between a first working chamber of the actuator connected to the first working port and a second working chamber of the actuator connected to the second working port. This equalization of the first working pressure in the first working chamber with the second working pressure in the second working chamber, which preferably leads to a complete pressure equalization between the two working chambers, so that a difference between the first working pressure and the second working pressure disappears, the actuator can be quickly transferred from a previous working movement caused by a pressure difference between the first working pressure and the second working pressure into a standstill state, thereby quickly and reliably reducing or eliminating a possible hazard caused by the actuator. Since the first safety valve and the second safety valve are designed to be fluidically pilot-controlled independently of one another and are fluidically connected in parallel with one another with respect to the first working port and the second working port, an advantageous level of safety is thereby ensured by the safety valve arrangement.

Supplementary or alternatively, it is provided that the second safety valve is optionally formed in the same way as the first safety valve, as the case may be, in the fluid distributor, whereby an interface between the fluid distributor and the safety valve can be dispensed with, so that greater functional safety can be ensured for the safety valve arrangement in this respect as well.

It is expedient if a third pilot valve is arranged on the fluid distributor, which is designed for selective release or blocking of a third pilot channel formed in the fluid distributor and extending between a third pilot air inlet and a third pilot air outlet, the separation channel being arranged between the first supply channel and the third pilot channel. The task of this third pilot valve and the associated third pilot channel consists, for example, in the fluidic pilot control of a third supply valve which is also to be connected to the fluid distributor and which is designed to release or block a fluidically communicating connection between the first supply port or the second supply port or a third supply port and a third working port, wherein, for example, a fluidically controllable braking device for the actuator is connected to the third working port, which braking device, when a safety function for the actuator is triggered, for example, intervenes in the actuator in such a way that the actuator is brought to a standstill rapidly or suddenly from a previous movement.

The task of the invention is also solved by an actuator system with a safety valve arrangement according to the invention, wherein a pneumatic actuator is designed as an actuator from the group: piston rod cylinder, rodless cylinder, swivel actuator, diaphragm actuator, air actuator, for providing a drive movement and wherein a first consumer port of the pneumatic consumer is connected to the first working port. Exemplarily, the pneumatic actuator is arranged in a processing machine or an industrial robot for providing a relative movement between two machine components or robot components coupled to each other in a linearly movable or pivotally movable manner.

Preferably, the pneumatic actuator is designed as a double-acting drive and has a second consumer port which is connected to the second working port.

In a further embodiment of the actuator system, it is provided that a pneumatically controlled braking device is assigned to the pneumatic consumer and that a third working port of the braking device is pneumatically connected to the third control air output.

### BRIEF DESCRIPTION OF THE DRAWINGS

An advantageous embodiment of the invention is shown in the drawing. It shows:

FIG. 1 a strictly schematic fluid circuit diagram for an actuator system equipped with a safety valve arrangement,

FIG. 2 a perspective view of a fluid distributor for the safety valve arrangement, and

FIG. 3 a top view of a second channel plate of the safety valve arrangement according to FIG. 2.

### DETAILED DESCRIPTION OF THE INVENTION

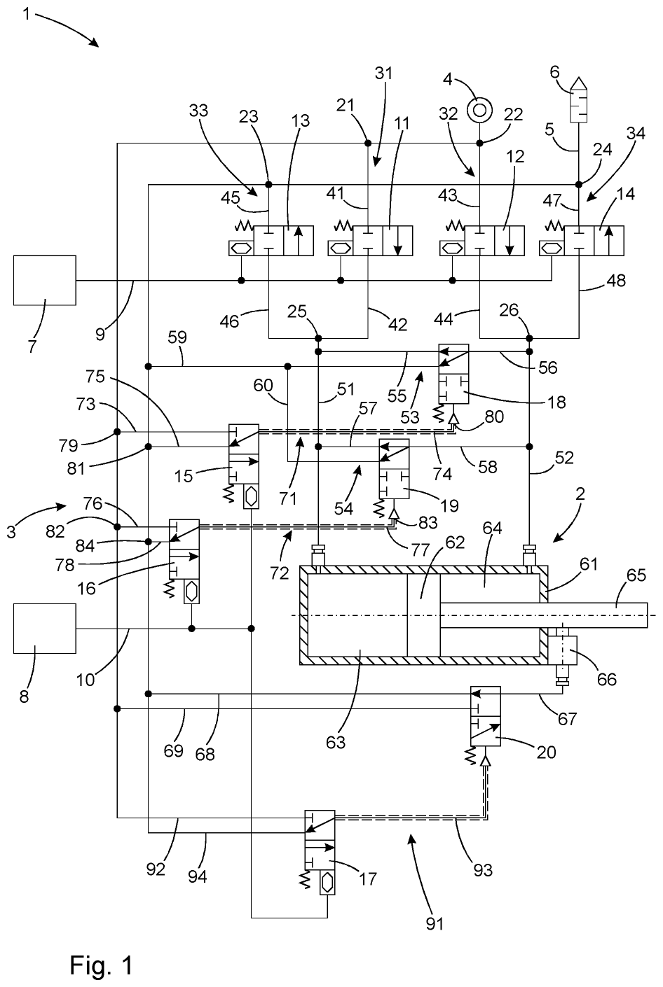

An actuator system 1 shown in FIG. 1 comprises an actuator 2, which is purely exemplary in the form of a double-acting pneumatic cylinder, a safety valve arrangement 3, a compressed air source 4, a pressure fluid sink 5 in the form of an air outlet with silencer 6, a supply valve control 7 and a safety valve control 8.

By way of example, the actuator 2 can be used to move an arm part, which is not shown, of a robot arm, which is also not shown, whereby the robot arm can be operated in an area in which people are also present, so that suitable precautions must be taken to prevent hazards to people from movements of the robot arm. For this purpose, it can be provided that the actuator 2 is supplied with compressed air by means of the safety valve arrangement 3 described in more detail below, which is designed to provide the quickest possible shutdown of the actuator 2 in the event of a hazardous situation.

In the following description of the safety valve arrangement 3 it is assumed that a central compressed air supply is provided by the compressed air source 4 as well as a central venting is provided by the pressure fluid sink 5. In an alternative design of the safety valve arrangement not shown, it can also be provided that individual areas of the safety valve arrangement and fluidic components connected thereto are supplied by different compressed air sources and/or compressed air is discharged from different areas of the safety valve arrangement via separate pressure fluid sinks.

By way of example only, the safety valve arrangement comprises four supply valves 11 to 14, three pilot valves 15, 16, 17, two safety valves 18 and 19, and a brake valve 20. By way of example, the supply valves 11 to 14 and the pilot valves 15 to 17 are designed as piezoelectric valves, while the two safety valves 18 and 19 and the brake valve 20 are each designed as fluidically pilot-controlled pneumatic valves.

The first supply valve 11, which can also be referred to as the first ventilation valve, is fluidically connected to a first supply port 21 via a first supply channel section 41 and to a first working port 25 via a second supply channel section 42. The first supply valve 11 enables selective release or blocking of a first supply channel 31 formed by the first supply channel section 41 and the second supply channel section 42.

The second supply valve 12, which can also be referred to as a second ventilation valve, is fluidically connected to a first supply port 22 via a first supply channel section 43 and to a second working port 26 via a second supply channel section 44. The second supply valve 12 enables selective release or blocking of a second supply channel 32 formed by the first supply channel section 43 and the second supply channel section 43.

The third supply valve 13, which may also be referred to as a first vent valve, is fluidly communicatively connected to a first exhaust port 23 via a first vent channel section 45 and to the first working port 25 via a second vent channel section 46. The third supply valve 13 enables selective release or blocking of a first vent channel 33 formed by the first vent channel section 45 and the second vent channel section 46.

The fourth supply valve 14, which may also be referred to as a second vent valve, is connected to a second exhaust port 24 via a first vent channel section 47 and is fluidly connected to the second working port 26 via a second vent channel section 48. The fourth supply valve 14 allows selective release or blocking of a second vent channel 34 formed by the first vent channel section 47 and the second vent channel section 48.

Starting from the first working port 25, a first working channel 51 extends to a first working chamber 63 of the actuator 2. Starting from the second working port 26, a second working channel 52 extends to a second working chamber 64 of the actuator 2. The first working chamber 63 and the second working chamber 64 are separated from one another by a working piston 62 which is accommodated to be linearly movable in a cylinder housing 61 and is thus variable in size. A force exerted by the working piston 62 on a piston rod 65, which passes through the end of the cylinder housing 61, depends on a pressure difference between the first working chamber 63 and the second working chamber 64 as well as on a geometric design of the cylinder housing 61, the working piston 62 and the piston rod 65.

A first safety channel section 55 and a second safety channel section 56 of a first safety channel 53 and a first safety channel section 57 and a second safety channel section 58 of a second safety channel 54 extend between the first working channel 51 and the second working channel 52.

s A first safety valve 18 is arranged in the first safety channel 53, which first safety valve 18 is a fluidically pilot-controlled switching valve biased into an open position and which thus releases a fluidically communicating connection between the first working channel 51 and the second working channel 52 in a first functional position in which no fluidic control is provided. This ensures that any pressure difference between the first working chamber 63 and the second working chamber 64 can be reduced to zero during a pressure equalization process. Purely exemplarily and only optionally, the first safety valve 18 is designed as a 3/2-way valve and is in fluidic communication with the pressure fluid sink 5 in the release position via a first exhaust line 59. By this measure, in the release position of the first safety valve 18, a pressure level in the first working chamber 63 and the second working chamber 64 is lowered to an ambient pressure prevailing in the vicinity of the safety valve arrangement 3.

A second safety valve 19 is arranged in the second safety channel 54, which second safety valve 19 is a fluidically pilot-controlled switching valve biased into an open position and which thus releases a fluidically communicating connection between the first working channel 51 and the second working channel 52 in a first functional position in which no fluidic control is provided. Optionally, the second safety valve 19 is a 3/2-way valve and is in fluidic communication with the pressure fluid sink 5 in the release position via a second exhaust line 60. By this measure, in the release position of the second safety valve 19, a pressure level in the first working chamber 63 and in the second working chamber 64 is lowered to an ambient pressure prevailing in the vicinity of the safety valve arrangement 3.

Fluidic pilot control for the first safety valve 18 is provided by a first pilot valve 15, which is designed purely exemplarily as a piezoelectric 3/2-way valve. The first pilot valve 15 is arranged in a first pilot channel 71, which is formed by a first pilot channel section 73, a second pilot channel section 74 and a third pilot channel section 75. The first pilot channel section 73 extends from a first pilot air inlet 79, which is connected to the compressed air source 4, to the first pilot valve 15. The second pilot channel section 74 extends from the first pilot valve 15 to the first pilot air outlet 80, which is formed at the first safety valve 18, and the third pilot channel section 75 extends from the first pilot valve 15 to the first exhaust air outlet 81, which is connected to the pressure fluid sink 5.

Fluidic pilot control for the second safety valve 19 is provided by a second pilot valve 16, which is designed purely exemplarily as a piezoelectric 3/2-way valve. The second pilot valve 16 is arranged in a second pilot channel 72, which is formed by a first pilot channel section 76, a second pilot channel section 77 and a third pilot channel section 78. The first pilot channel section 76 extends from a second pilot air inlet 82, which is connected to the compressed air source 4, to the second pilot valve 16. The second pilot channel section 77 extends from the second pilot valve 16 to the second pilot air outlet 83 formed at the second safety valve 19, and the third pilot channel section 78 extends from the second pilot valve 16 to the second exhaust air outlet 84 connected to the compressed fluid sink 5.

Furthermore, the actuator system 1 comprises a pneumatically controllable brake 66, which is configured purely exemplarily for a frictional and/or positive brake engagement on the piston rod 65. The brake 66 is configured in such a way that it engages the piston rod 65 without a pressure supply and releases the brake engagement on the piston rod 65 when pressure is applied. For this purpose, the brake 66 is connected via a brake control line 67 to a brake valve 20, which is designed purely exemplarily as a fluidically pilot-controlled 3/2-way valve biased into a release position. The brake valve 20 is in fluidic communication with the pressure fluid sink 5 via an exhaust channel 68 and in fluidic communication with the pressure air source 4 via a vent channel 69.

The brake valve 20 is controlled via a third pilot channel 91, which comprises a first pilot channel section 92, a second pilot channel section 93 and a third pilot channel section 94. Here, it is provided that the first pilot channel section 92 is formed between the compressed air source 4 and the third pilot valve 17, that the second pilot channel section 93 is formed between the third pilot valve 17 and the brake valve 20, and that the third pilot channel section 94 is formed between the third pilot valve 17 and the pressure fluid sink 5. Furthermore, the third pilot valve 17 is designed as an electrically controlled 3/2-way valve in the same way as the first pilot valve 15 and the second pilot valve 16.

The supply valves 11 to 14 are electrically controlled from a supply valve control unit 7 via a supply valve control line 9, which is designed in such a way that each of the supply valves 11 to 14 can be individually supplied with an electrical voltage in order to control the respective supply valve 11 to 14 separately.

The pilot valves 15 to 17 are electrically controlled from a safety controller 8 via a safety control line 10, which is designed in such a way that each of the pilot valves 15 to 17 can be individually supplied with an electrical voltage in order to separately control the respective pilot valve 15 to 17.

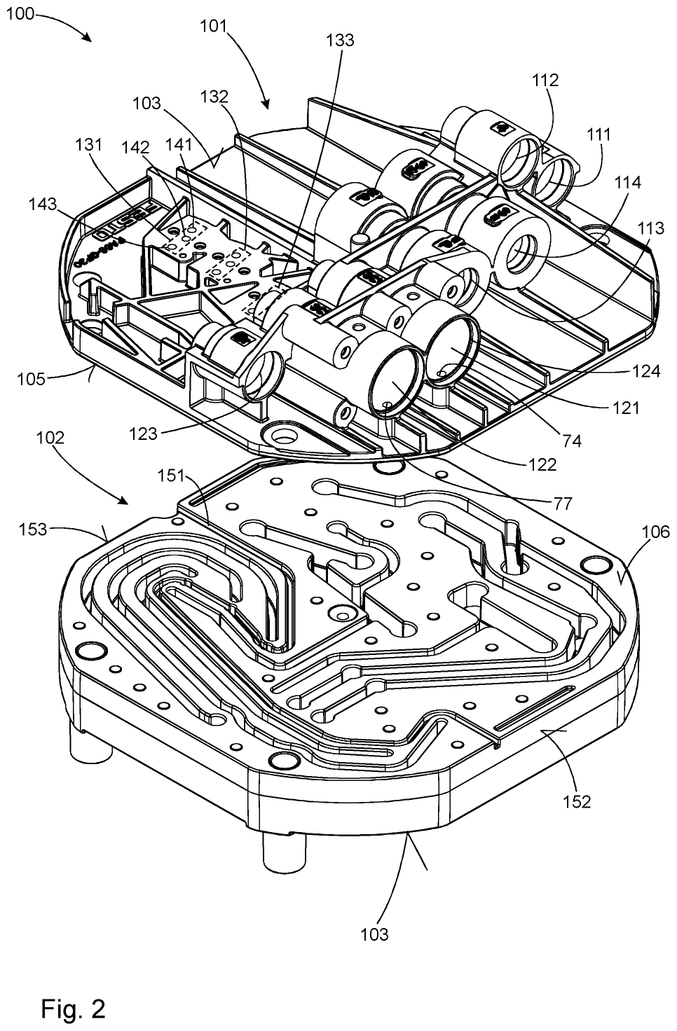

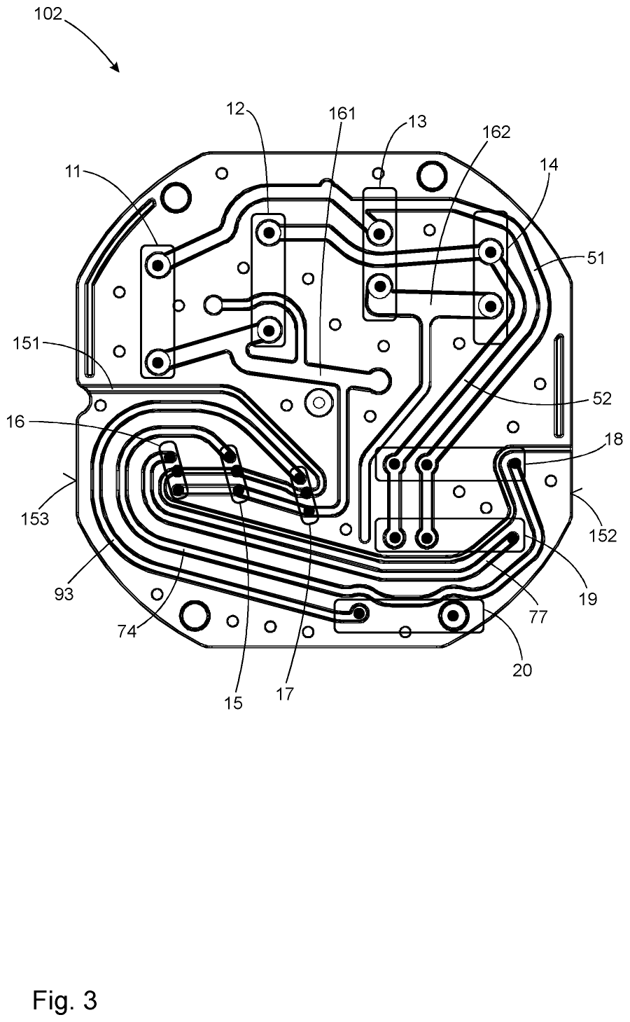

The schematic diagram in FIG. 1 shows that the second pilot channel section 74 of the first pilot channel 71, the second pilot channel section 77 of the second pilot channel 72 and the second pilot channel section 93 of the third pilot channel 91 are each provided with additional protection, as symbolized by the dashed lines on both sides. This additional protection is provided by a separation channel as described below in connection with the description of FIGS. 2 and 3.

FIG. 2 shows a fluid distributor 100 for the safety valve arrangement 3 as schematically shown in FIG. 1. The fluid distributor 3 includes the channels and channel sections described above in connection with FIG. 1 and is constructed, purely by way of example, from a first channel plate 101 and a second channel plate 102.

By way of example, the first channel plate 101 is provided on a first outer surface 103 with a first working port 111, a second working port 112, a supply port 113 for connection to the compressed air source 4, and a supply port 114 for connection to the pressurized fluid sink 5. Each of these ports 111 to 114 is fluidically connected to an orifice opening at the first inner surface 105 of the first channel plate 101 via a channel section not shown in detail.

Furthermore, a first valve shaft 121 for the first safety valve 18, a second valve shaft 122 for the second safety valve 19 and a third valve shaft 123 for the brake valve 20 are formed on the first outer surface 103 of the first channel plate 101. As can be seen from the illustration in FIG. 2, the second pilot channel section 74 of the first pilot channel 71 opens into the first valve shaft 121. Furthermore, the second pilot channel section 77 of the second pilot channel 72 opens into the second valve shaft 122. The second pilot channel section 93 of the third pilot channel 91 opens into the third valve shaft 123 in a manner not shown.

By way of example, it is envisaged that a valve member, which is not shown and is designed in the manner of a working piston, can be accommodated in the first valve shaft 121, which is of circular-cylindrical design, and that the opening visible in FIG. 2 is subsequently closed, as a result of which the valve member forms a working space with the first valve shaft 121, into which the second pilot channel section 74 of the first pilot channel 71 opens. Furthermore, the valve member, which is not shown, can be preloaded with a spring, which is also not shown, in the direction of the first opening 124 in such a way that, in the absence of pressurization for the second pilot channel section 74, there is a fluidically communicating connection between the first working channel 51 and second working channel 52 shown in FIG. 1. When pressure is applied to the second pilot channel section 74, a linear displacement of the valve member, which is also not shown, takes place against the bias of the spring not shown, during which the valve member moves away from the first opening 124 and the fluidically communicating connection between the first working channel 51 and the second working channel 52 shown in FIG. 1 is interrupted.

In the same way, the second safety valve 19 can be realized in the second valve shaft 122 and the brake valve 20 in the third valve shaft 123, whereby the control of the second safety valve 19 is effected by pressurization of the second pilot channel section 77 of the second pilot channel 72 and the control of the brake valve 20 is effected by pressurization of the second pilot channel section 93 of the third pilot channel 91.

As can also be seen from the illustration in FIG. 2, a total of three interfaces 131, 132 and 132 are formed on the first outer surface 103 of the first channel plate 101, which are designed for the mechanical and fluidic coupling of the pilot valves 15 to 17 not shown in greater detail in FIG. 2. For example, three orifices 141, 142, 143 are formed at the first interface 131, which are assigned to the three pilot channel sections 73, 74 and 75 of the first pilot channel 71, into which the first pilot valve 15 is fluidically looped. Similarly, the other two interfaces 132 and 133 each have unspecified orifices for the likewise unspecified pilot channel sections.

The second inner surface 106 of the second channel plate 102 is provided with a plurality of groove-shaped or channel-like recesses which, when the first channel plate 101 is placed with its first inner surface 105 on the second inner surface 106 in a sealing manner, form a plurality of channels as already described in connection with FIG. 1.

It is decisive that between the second pilot channel sections 74, 77 and 93 serving for fluidic pilot control of the safety valves 18 and 19 as well as of the brake valve 20 and the other channels formed in the fluid distributor 100, a separation channel 150 is arranged, which is also provided as a groove-shaped or channel-shaped recess in the second inner surface 106 of the second channel plate 102 and which opens out at opposite side surfaces 152, 153 of the second channel plate 102.

The function of this separation channel 151 is to prevent overflow of pressurized fluid in the event of leaks occurring between the first channel plate 101 and the second channel plate 102, which pressurized fluid is supplied by the compressed air source 4 at the supply port 113 and is guided in the supply channel in the fluid distributor 100 described in more detail below, into the second pilot channel sections 74, 77 and 93, since this could result in undesired actuation of the safety valves 18, 19 and/or the brake valve 20.

As can be seen from the illustration of FIG. 3, the separation channel 151 also serves to vent/aerate the pilot valves 15, 16 and 17, each of which is shown only schematically. For the pilot valves 15, 16 and 17 as well as for the supply valves 11 to 14, the safety valves 18 and 19 and the brake valve 20, it applies in the representation of FIG. 3 that each of these valves 14 to 20 is symbolized by a circulating frame and is fluidically connected only to those channels in which a filled circle is also drawn.

Thereby, the first pilot valve 15 enables an optional fluidically communicating connection either between the second pilot channel section 74 and a supply channel 161, which is fluidically connected to the supply port 113, or between the second pilot channel section 74 and the separation channel 151. The second pilot channel section 74 is provided, as described above, for fluidically pilot-controlling the first safety valve 18, which in turn is adapted for selectively enabling or blocking a fluidically communicating connection between the first working channel 51 and the second working channel 52.

The second pilot valve 16 provides a selective fluidic connection between either the second pilot channel section 77 and the supply channel 161, which is fluidically connected to the vent port 113, or between the second pilot channel section 77 and the separation channel 151. The second pilot channel section 77 is provided, as described above, for a fluidic control of the second safety valve 19, which in turn is adapted for selectively releasing or blocking a fluid connection between the first working channel 51 and the second working channel 52.

The third pilot valve 17 provides selective fluid communication between either the second pilot channel section 93 and the supply channel 161, which is fluidly communicatively connected to the vent port 113, or between the second pilot channel section 93 and the separation channel 151. The second pilot channel section 93 is provided, as already described above, for the fluidic pilot control of the brake valve 20, which in turn is designed for venting or bleeding the brake 66.

The supply valves 11 to 14, shown schematically in FIG. 3, enable the first working chamber 63 and the second working chamber 64 of the actuator 2 to be optionally ventilated or exhausted, as described above for FIG. 1.

1. A safety valve arrangement for a protected pneumatic supply of an actuator, comprising a fluid distributor to which a first supply valve, a first pilot valve and a first safety valve are assigned, wherein the first supply valve selectively releases or blocks a first supply channel which is located in the fluid distributor and which extends between a first supply port and a first working port, wherein the first pilot valve selectively releases or blocks a first pilot channel which is located in the fluid distributor and which extends between a first pilot air inlet and a first pilot air outlet, and wherein the first safety valve selectively releases or blocks a first safety channel which extends between the first working port and a first safety outlet in dependence on pressurization of the first pilot air outlet, wherein a first separation channel, which is permanently open to the environment, is located between said first supply channel and said first pilot channel to ensure a fluid separation between said first supply channel and said first pilot channel.

2. The safety valve arrangement according to claim 1, wherein the fluid distributor comprises a first channel plate and a second channel plate, wherein the first supply channel and the first pilot channel and the first safety channel and the first separation channel are each formed as a groove on a first inner surface of the first channel plate and/or on a second inner surface of the second channel plate, and wherein the first inner surface and the second inner surface are connected to one another in a sealing manner.

3. The safety valve arrangement according to claim 2, wherein the first inner surface and the second inner surface are designed to correspond geometrically to one another.

4. The safety valve arrangement according to claim 2, wherein a first supply valve interface for mounting the first supply valve and a first pilot valve interface for mounting the first pilot valve are located on a first outer surface of the first channel plate facing away from the first inner surface, wherein the first supply channel comprises a first supply channel section extending between the first supply port and a first interface mouth of the first supply valve interface and a second supply channel section extending between a second interface mouth of the first supply valve interface and the first working port, and wherein the first pilot channel has a first pilot channel section extending between the first pilot air inlet and a first interface mouth of the first pilot valve interface and a second pilot channel section extending between a second interface mouth of the first pilot valve interface and the first pilot air outlet.

5. The safety valve arrangement according to claim 1, wherein a first valve recess is formed in the fluid distributor for the first safety valve, and wherein the first pilot air outlet opens into a first working space bounded by the first valve recess, wherein a first safety valve member is movably accommodated in the first valve recess, wherein the first safety valve member is biased in the first valve recess into a first functional position in which the first safety channel is unblocked, and wherein the first safety valve member assumes a second functional position in which the first safety channel is blocked when the first working chamber is pressurized with a control pressure.

6. The safety valve arrangement according to claim 1, wherein a second supply valve, a second safety valve and a second pilot valve are arranged on the fluid distributor, wherein the second supply valve selectively releases or blocks a second supply channel which is located in the fluid distributor and which extends between a second supply port and a second working port, wherein the second pilot valve selectively releases or blocks a second pilot channel which is located in the fluid distributor and which extends between a second pilot air inlet and a second pilot air outlet, wherein the second safety valve selectively releases or blocks a second safety channel which extends between the first working port and the second working port, wherein the separation channel is arranged between the second supply channel and the second pilot channel.

7. The safety valve arrangement according to claim 6, wherein the first safety outlet is connected to the second working port and/or wherein a second valve recess is formed in the fluid distributor for the second safety valve, and wherein the second pilot air outlet opens into a second working space bounded by the second valve recess and a second safety valve member accommodated movably in the second valve recess, wherein the second safety valve member is biased in the second valve recess into a first functional position in which the second safety channel is unblocked and wherein the second safety valve member assumes a second functional position in which the safety channel is blocked when the second working chamber is pressurized with a control pressure.

8. The safety valve arrangement according to claim 1, wherein a third pilot valve is arranged on the fluid distributor, which third pilot valve selectively releases or blocks a third pilot channel which is located in the fluid distributor and which extends between a third pilot air inlet and a third pilot air outlet, the separation channel being arranged between the first supply channel and the third pilot channel.

9. An actuator system comprising a safety valve arrangement, the safety valve arrangement comprising a fluid distributor to which a first supply valve, a first pilot valve and a first safety valve are assigned, wherein the first supply valve selectively releases or blocks a first supply channel which is located in the fluid distributor and which extends between a first supply port and a first working port, wherein the first pilot valve selectively releases or blocks a first pilot channel which is located in the fluid distributor and which extends between a first pilot air inlet and a first pilot air outlet, and wherein the first safety valve selectively releases or blocks a first safety channel which is located in the fluid distributor and which extends between the first working port and a first safety outlet in dependence on pressurization of the first pilot air outlet, wherein a first separation channel, which is permanently open to the environment, is located between said first supply channel and said first pilot channel to ensure a fluid separation between said first supply channel and said first pilot channel, the actuator system further comprising a pneumatic actuator from the group: piston rod cylinder, rodless cylinder, swivel drive, diaphragm drive, air actuator, wherein a first consumer port of the actuator is connected to the first working port.

10. The actuator system according to claim 9, wherein the safety valve arrangement comprises a second supply valve and a second safety valve and a second pilot valve which are arranged on the fluid distributor, wherein the second supply valve selectively releases or blocks a second supply channel which is located in the fluid distributor and which extends between a second supply port and a second working port, wherein the second pilot valve selectively releases or blocks a second pilot channel which is located in the fluid distributor and which extends between a second pilot air inlet and a second pilot air outlet, wherein the second safety valve selectively releases or blocks a second safety channel which extends between the first working port and the second working port, wherein the separation channel is arranged between the second supply channel and the second pilot channel and wherein the actuator is a double-acting drive and has a second consumer port, which is connected to the second working port.

11. The actuator system according to claim 10, wherein a third pilot valve is arranged on the fluid distributor, which third pilot valve selectively releases or blocks a third pilot channel which is located in the fluid distributor and which extends between a third pilot air inlet and a third pilot air outlet, the separation channel being arranged between the first supply channel and the third pilot channel, wherein a pneumatically controlled brake is assigned to the actuator and wherein a third working port of the brake is pneumatically connected to the third pilot air outlet.
